(19) United States
(12) Patent Application Publication
(10) Pub. No.: US 2008/0034644 A1
(43) Pub. Date: Feb. 14, 2008

(54) Solid pesticide distribution system

(75) Inventors: Peter Eldridge, Miami Beach, FL (US); Gary Ray Colerider, Rockledge, FL (US)

Correspondence Address: MARK TERRY, 950 Peninsula Corporate Circle, Suite 3020, Boca Raton, FL, 33487, US

(73) Assignee: Apex Pest Control, Inc.

(21) Appl. No.: 11/503,761

(22) Filed: Aug. 14, 2006

(51) Int. Cl. A01M 9/00

(52) U.S. Cl. 43/124; 43/132.1

(57) ABSTRACT

A system for distributing a solid pesticide within interior cavities of a building is disclosed. The system includes a panel coupled to an exterior wall of the building. The system further includes at least one orifice in the panel providing access to an interior cavity of the building, wherein the at least one orifice comprises an exterior-facing end and an interior-facing end. The system further includes a plurality of tubes located within interior cavities of the building, wherein each of the plurality of tubes comprises a plurality of apertures for expelling a solid pesticide and wherein each of the tubes is coupled at an open end to an interior-facing end of at least one orifice in the panel. A solid pesticide may be injected into an exterior-facing end of the at least one orifice, thereby distributing the solid pesticide throughout the interior cavities of the building via the tubes.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention relates to pesticides, and more particularly to improved systems for distributing solid pesticides in building structures.

### BACKGROUND OF THE INVENTION

Permanent pesticide distribution systems for buildings typically take the form of tubes or pipes that are wound through various areas within the building so as to automatically distribute pesticide and eliminate the need for manually applying the pesticide in every area, crack or crevice of the building. One problem with these conventional approaches to pesticide distribution lies with the safety of the pesticides used.

Conventional pesticide distribution systems for buildings use liquid or gas pesticides that possess a wet quality. The use of these pesticides within interior cavities of buildings where the atmosphere can be damp, warm and dark can promote the growth of mold, which is currently a widely held public health concern. Further, liquid or gas pesticides require pressurization and/or compression in order to inject them into a system of tubes, thereby requiring pressurized devices or apparatuses to deliver the pesticide. Moreover, when liquid or gas pesticides are exposed to the atmosphere, they can dry up, dissipate or sublimate rather quickly, thereby reducing their pest control properties.

Therefore, a need exists to overcome the problems with the prior art as discussed above, and particularly for a safer and more efficient way for distributing pesticide throughout a building.

### SUMMARY OF THE INVENTION

Briefly, according to an embodiment of the present invention, a system for distributing a solid pesticide within interior cavities of a building is disclosed. The system includes a panel coupled to an exterior wall of the building. The system further includes at least one orifice in the panel providing access to an interior cavity of the building, wherein the at least one orifice comprises an exterior-facing end and an interior-facing end. The system further includes a plurality of tubes located within interior cavities of the building, wherein each of the plurality of tubes comprises a plurality of apertures for expelling a solid pesticide and wherein each of the plurality of tubes is coupled at an open end to an interior-facing end of at least one orifice in the panel. A solid pesticide may be injected into an exterior-facing end of the at least one orifice, thereby distributing the solid pesticide throughout the interior cavities of the building via the plurality of tubes.

In another embodiment of the present invention, a method for providing a system for distributing a solid pesticide within interior cavities of a building is disclosed. The method includes installing a panel coupled to an exterior wall of the building, wherein the panel includes at least one orifice providing access to an interior cavity of the building, wherein the at least one orifice comprises an exterior-facing end and an interior-facing end. The method further includes installing a plurality of tubes located within interior cavities of the building, wherein each of the plurality of tubes comprises a plurality of apertures for expelling a solid pesticide and wherein each of the plurality of tubes is coupled at an open end to an interior-facing end of at least one orifice in the panel. A solid pesticide may be injected into an exterior-facing end of the at least one orifice, thereby distributing the solid pesticide throughout the interior cavities of the building via the plurality of tubes.

In another embodiment of the present invention, method for distributing a solid pesticide within interior cavities of a building is disclosed. The method includes injecting a solid pesticide into at least one orifice in a panel coupled to an exterior wall of the building, wherein each of the at least one orifices provide access to a tube extending within interior cavities of the building and wherein each tube comprises a plurality of apertures for expelling the solid pesticide, thereby distributing the solid pesticide throughout the interior cavities of the building via each tube. The method further includes injecting an inert gas into the at least one orifice in the panel, thereby flushing solid pesticide remaining within each tube into the interior cavities of the building via the plurality of apertures in each tube.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIG. 1A is an illustration of a building structure including the solid pesticide distribution system during use, according to one embodiment of the present invention.

FIG. 1B is an illustration showing a more detailed view of the solid pesticide distribution system of FIG. 1A.

FIG. 2 is an illustration of a frontal perspective view of a junction box used with the solid pesticide distribution system, according to one embodiment of the present invention.

FIG. 3 is an illustration of rear perspective view of the junction box of FIG. 2.

FIG. 4 is an illustration of a side perspective view of a duster apparatus used with the solid pesticide distribution system, according to one embodiment of the present invention.

FIG. 5 is an illustration of a side perspective view of an air compressor used with the solid pesticide distribution system, according to one embodiment of the present invention.

### DETAILED DESCRIPTION

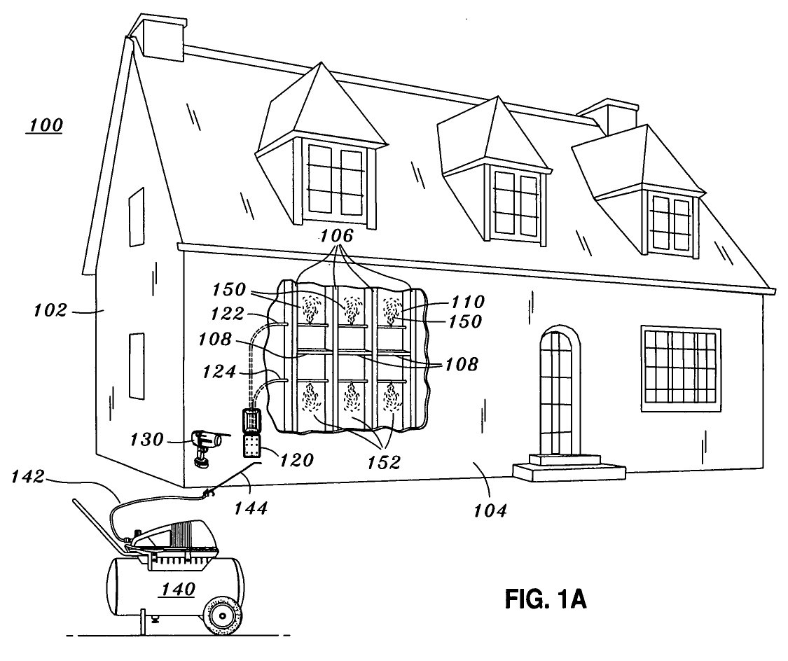

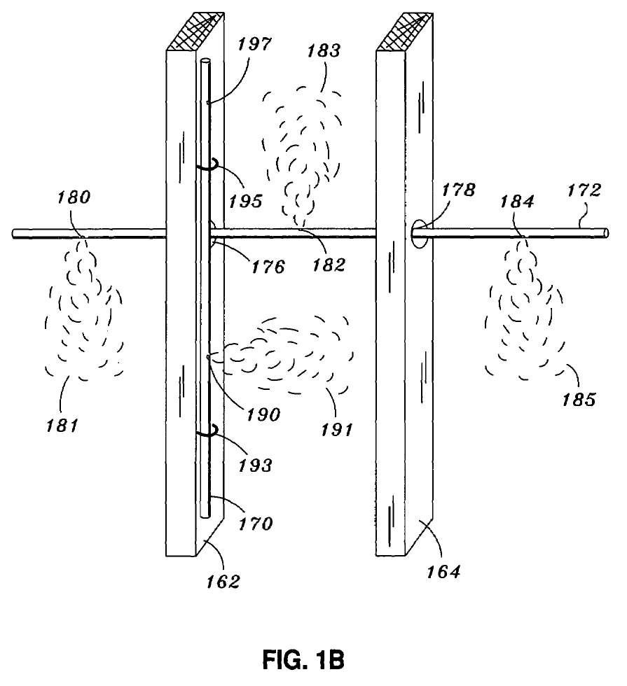

FIG. 1A is an illustration of a building structure 102 including the solid pesticide distribution system 100 during use, according to one embodiment of the present invention. In general, the solid pesticide distribution system 102 comprises a plurality of perforated tubes 122, 124 embedded within the interior cavities 110 of a building structure 102, wherein solid pesticide is injected through the tubes so as to apply the pesticide within the interior cavities 110 of the building structure 102. FIG. 1A shows a building structure 102, such as a home, an office building or other structure inhabited by humans. Also shown in FIG. 1A is a wall 104 of the building structure 102, including a cutout of the wall 104 showing interior building cavities 110. The interior building cavities 110 may be any volume within the walls or other confines of the building structure 102, such as spaces within walls, crawl spaces under the floor, crawl spaces in the roof or any other space that is not accessible by inhabitants of the building structure 102.

Within the interior building cavities 110, FIG. 1A shows vertical studs 106, which may be standard two-by-four inch wooden studs used to lend structural strength to the building structure 102. Also shown are horizontal studs 108, which may also be standard two-by-four inch wooden studs lending structural strength to the building structure 102. Although FIG. 1A only depicts interior building cavities 110 located within vertical walls of the building 102, the present invention supports the dissemination of the tubes 122, 124 throughout other interior cavities of the building 102, such as crawl spaces under the floor or crawl spaces in the roof of the building 102.

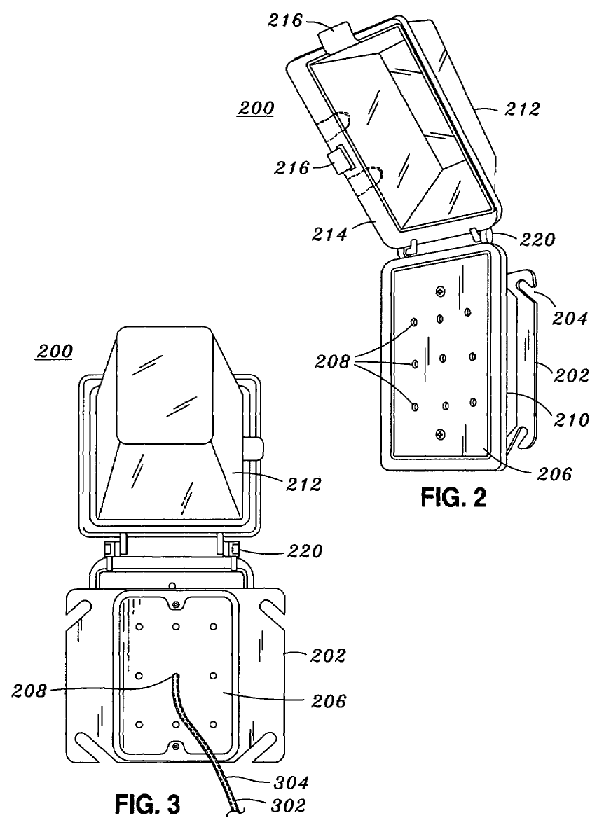

Coupled to the exterior of the wall 104 is a junction box 120, which acts as a receptacle for holding the ends of a plurality of tubes 122, 124. The junction box 120 is described in more detail below with reference to FIG. 2. Each tube 122, 124 extends through the interior cavities 110 of the wall 104 by winding through the studs 106, 108 of the wall. An open end of each tube 122, 124 terminates at the junction box 120, while the opposite end of each tube 122, 124 is closed or obstructed. Each tube 122, 124 includes a plurality of orifices through which solid pesticide is expelled when injected into the tubes 122, 124. It should be noted that although only two tubes 122, 124 are shown in FIG. 1A, the present invention supports any number of tubes originating at the junction box 120.

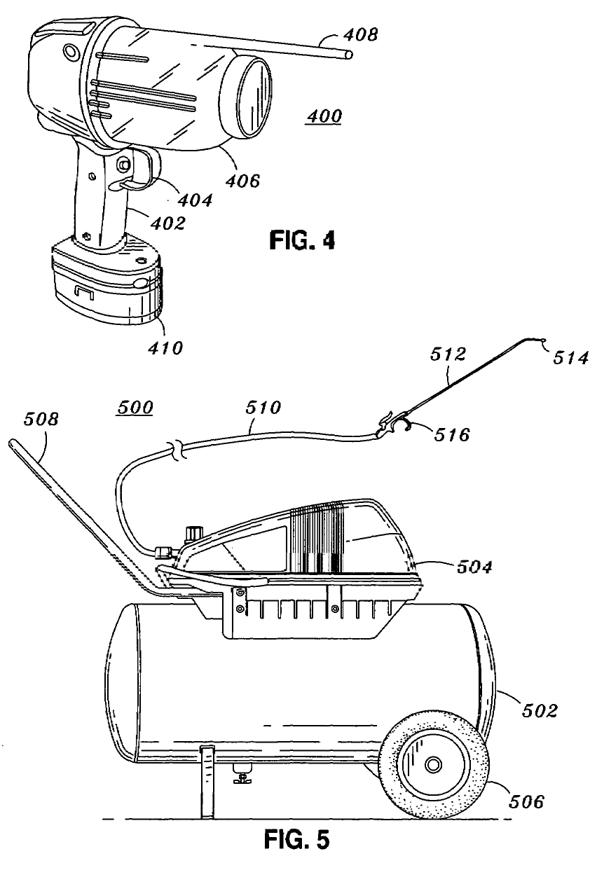

FIG. 1A also shows a duster gun 130, or dust applicator, which is used to inject a solid pesticide in dry, powder form into the tubes 122, 124. The duster gun 130 comprises an electrical apparatus that includes a receptacle for holding a solid pesticide in dry, powder form and a motor for producing a flow of air that is expelled from a nozzle as a mixture of air and solid pesticide. The duster gun 130 is described in more detail below with reference to FIG. 4. Note that although FIG. 1A shows the use of a dust applicator in inject solid pesticide into the tubes 122, 124, the present invention supports the use of alternative devices for injecting solid pesticide into the tubes 122, 124, such as a manual-powered bellows-type puffer bottle or dust applicator, a snuffer applicator or bellows dispenser, a bulb duster or a dust gun.

FIG. 1A further shows an air compressor 140 for flushing out solid pesticide that is situated within the tubes 122, 124. The air compressor 140 includes a hose 142 for directing pressurized air from the compressor 140 to an air gun 144 that includes a nozzle for applying the pressurized air to a precise point or location. After injection of the tubes 122, 124 with solid pesticide, the tubes 122, 124 are flushed out with compressed air (at a pressure of 125 psi, for example) from the air compressor 140, thereby producing plumes of radiating solid pesticide 150 from tube 122 and plumes of radiating solid pesticide 152 from tube 124. The air compressor 140 is described in more detail below with reference to FIG. 5.

The present invention, as embodied in the solid pesticide distribution system 100 of FIG. 1, allows for the quick and easy distribution of solid pesticide within the interior cavities of a building structure 102. The solid pesticide distribution system 100 is beneficial as it can be installed in a building structure 102 in a short period of time, typically during the construction phase of the building 102. The tubes 122, 124 (and any other tubes not shown) are usually installed during the same phase that electrical and plumbing components are installed in a building. Because the tubes 122, 124 are thin, lightweight and easy to handle, installation of the tubes 122, 124, as well as installation of the junction box 120 on the exterior wall 104 of the building 102, is accomplished in a few hours and requires minimal effort and materials.

The solid pesticide distribution system 100 is further beneficial as it allows a certified pest control technician to apply solid pesticide to all interior cavities of a building 102 with minimal exertion. The technician is required only to make one trip to the junction box 120, wherein the technician can inject solid pesticide into all orifices in the junction box 120 and thereby service all interior cavities serviced by each tube. Further, because the junction box 120 is located on the exterior of the building, the technician is not required to enter the residence, thereby eliminating the need for the owner of the home to be present or to wait for the technician. The technician may visit the building 102 periodically, such as every month, or only when the owner of the residence requests a service visit.

The solid pesticide distribution system 100 is further advantageous as it allows for the introduction of pesticide into areas that are difficult to reach, i.e., the interior cavities of a building. Further, because there are no outdoor elements within a building to dissipate the pesticide, less pesticide is required to achieve the same pest control effect. Moreover, the user of pesticides within interior cavities of a building is preferable since is reduces the hazard to humans or other animals living inside the building. Further, because the pesticide is applied within interior cavities of a building, there is a reduced chance of experiencing the scent of the pesticide or of items within the home, such as carpets, becoming stained.

FIG. 1B is an illustration showing a more detailed view of the solid pesticide distribution system 100 of FIG. 1. FIG. 1B shows greater detail for two tubes 172, 170 that are coupled, on one open end, to a junction box 120 (not shown), as described in FIG. 1A. Although FIG. 1B shows only two tubes 172, 170, the present invention supports any number of tubes originating at the junction box 120.

FIG. 1B shows vertical studs 162 and 164 includes orifices 176 and 178, respectively, used for winding the tube 172 through the vertical studs 162, 164, which may be standard two-by-four inch wooden studs used to lend structural strength to a building structure. Orifices 180, 182 and 184 are located in an approximately uniform fashion in the tube 172. In one example, the orifices 180, 182, 184 are spaced every twelve inches, although other spacing lengths are possible. The orifices 180, 182, 184 allow for the escape of solid pesticide to the interior cavities of the building. FIG. 1B shows solid pesticide plume 181 emanating from orifice 180, solid pesticide plume 183 emanating from orifice 182 and solid pesticide plume 185 emanating from orifice 184.

FIG. 1B further shows tube 170 coupled to vertical stud 162. The tube 170 may be fastened to vertical stud 162 using, for example, a staple-like apparatus 195, 193. Orifices 190, 197 are located in an approximately uniform fashion in the tube 170. The orifices 170, 174 allow for the escape of solid pesticide to the interior cavities of the building. FIG. 1B shows solid pesticide plume 191 emanating from orifice 190.

FIG. 2 is an illustration of a frontal perspective view of a junction box 200 used with the solid pesticide distribution system 100, according to one embodiment of the present invention. The junction box 200 corresponds to junction box 120 of FIG. 1. FIG. 2 shows a junction box 200 for affixing to the exterior wall 104 of a building 102 (see FIG. 1). In one embodiment of the present invention, the junction box 200 measures approximately 4.5 inches in height, 4 inches in width and 3.5 inches in depth, when the cover 212 is closed.

The junction box 200 includes a wall brace 202 for affixing the junction box 200 to the wall 104 of the building 102. The wall brace 202 includes a recess or fastener cutout 204 for allowing the use of a fastener such as a screw or a bolt when affixing the wall brace 202 to the wall 104. The junction box 200 further includes a planar panel 206 resting on top of the wall brace 202, wherein the planar panel 206 includes a plurality of holes or orifices 208 that extend through the panel 206 and provide access to interior cavities 110 of the wall 104. Each orifice 208 includes an exterior-facing end and an interior-facing end. In an embodiment of the present invention, each orifice 208 measures roughly 3/16 of an inch in diameter.

The junction box 200 also includes a cover 212 attached to the panel 206 via a hinge 220, wherein the cover 212 protects the panel 206 from the elements when closed and allows access to the orifices 208 when open. The junction box 200 also includes a raised edge 210 situated around the circumference of the planar element 206 and a raised edge 214 situated around the circumference of the cover 212. When the cover 212 is closed, the raised edge 210 contacts the raised edge 214 to create a seal so as to protect the inner volume of the junction box 200 from the elements, such as rain or snow.

FIG. 3 is an illustration of rear perspective view of the junction box 200 of FIG. 2. FIG. 3 shows the planar panel 206, the wall brace 202, the hinge 220 and the cover 212. Also shown is an orifice 208 in the planar panel 206, into which a tube 304 is inserted. As explained above, the tube 304 may include a closed or obstructed end and an open end that terminates at the planar panel 206. In an embodiment of the present invention, when installed in a building, the tube 304 would measure approximately 150 feet in length, 3/16 inch outer diameter and ⅛ inch inner diameter. The tube 304 may be comprised of a polymer substance such as plastic, vinyl, polyvinyl chloride, polyethylene, acrylic, silicone, or urethane. The tube 304 may include multiple perforations (a single perforation shown at 302) situated about every 12 inches along the length of the tube 304, so as to allow the expulsion of solid pesticide from the tube 304.

In one embodiment of the present invention, the open end of the tube 304 is directly inserted into the interior-facing end of the orifice 208 of the planar panel 206. The open end of the tube 304 is held securely in the orifice 208 simply by the gripping force of the orifice 208 around the circumference of the open end of the tube 304. The gripping force arises out of the identical size of the diameter of the orifice 208 and the outer diameter of the tube 304. Note that there are no additional features, elements or apparatus used to secure the open end of the tube 304 within the orifice 208. Again, the open end of the tube 304 is connected directly to the orifice 208 using no other intervening elements.

In another embodiment of the present invention, the open end of the tube 304 is directly inserted into the interior-facing end of the orifice 208 of the planar panel 206 while the other end of the tube 304 is also open and also directly inserted into the interior-facing end of an orifice of the planar panel 206. In this embodiment, when solid pesticide is injected into the orifice 208, the technician must occlude the orifice in which the opposing end of the tube 304 is inserted. This allows the solid pesticide to escape out of the perforations in the tube 304. The technician then injects an inert gas, such as air, into the orifice 208 so as to allow any solid pesticide remaining in the tube 304 to escape out of the perforations in the tube 304. Once the injection process has ended, the technician may then un-obstruct the orifice in which the opposing end of the tube 304 is inserted and proceed to inject the orifice 208 with the same inert gas. Any pesticide remaining in the tube 304 may then be flushed out of the orifice in which the opposing end of the tube 304 is inserted and may be captured in a container for re-use.

FIG. 4 is an illustration of a side perspective view of a duster gun apparatus 400 used with the solid pesticide distribution system 100, according to one embodiment of the present invention. The duster gun 400 is an electrical apparatus used to spray or spew dry, powder substances, in this case a solid pesticide, out of a nozzle element 408. The duster gun 400 includes a handle 402, for use by a technician, and a trigger 404 for activating the duster gun 400. The duster gun 400 further comprises a receptacle 406 for holding the dry, powder substance and a motor (not shown) for producing a flow of air that is expelled from a nozzle 408 as a mixture of air and the dry, powder substance, in this case a solid pesticide. The duster gun 400 may also include a battery pack 410 for powering the gun 400. An example of a commercially available duster gun 400 is the Power Puff duster gun available from Gremar, Inc. of West Des Moines, Iowa.

In one embodiment of the present invention, the battery pack 410 for powering the duster gun 400 may comprise a standard commercially available alkaline battery, such as an AA size or an AAA size battery that ranges from 1.5 volts to 9 volts each. Alternatively, the battery pack 410 may be any commercially available silver oxide or lithium battery providing from 1.5 to 3 volts. In another alternative, the battery pack 410 may be a nickel cadmium battery, a nickel metal hydride battery, a lithium ion battery, or a zinc air battery.

FIG. 5 is an illustration of a side perspective view of an air compressor 500 used with the solid pesticide distribution system 100, according to one embodiment of the present invention. The air compressor 500 includes an air container 502 for holding pressurized air, a motor module 504 for powering the apparatus, a wheel axle 506 for moving the air compressor 500 and a handle 508 for maneuvering the apparatus. The air compressor 500 further includes a hose 510 for directing pressurized air from the compressor 500 to an air gun 512 that includes a handle including a trigger 516, and a nozzle 514 for applying the pressurized air to a precise point or location. An example of a commercially available air compressor 500 is the 1.7 horsepower, 26 gallon, vertizontal air compressor available from Campbell Hausfeld of Harrison, Ohio.

After injection of the tubes 122, 124 (see FIG. 1) with solid pesticide, the tubes 122, 124 are flushed out with compressed air (at a pressure of 125 psi, for example) from the air compressor 500, thereby pushing any solid pesticide remaining in the tubes 122, 124 out of their respective orifices in the tubes. The nozzle 514 is inserted directly into the exterior-facing end of the orifices 208 of the panel 206 in the junction box 200 (see FIG. 2) and pressurized air is shot into the tubes 122, 124 to flush solid pesticide out of the inside volume of the tubes 122, 124.

The pesticide distribution system 100 utilizes a solid pesticide, i.e., a pesticide that is not in gas or liquid form. One example of a solid pesticide that may be used with the pesticide distribution system 100 is a dry, powder solution including the borate family of solid pesticides as the active ingredient. A borate is a compound of the borate ion with metallic elements. Boron found in nature is commonly found as a borate mineral. Boron is also found combined with silicate to form complex borosilicate minerals such as the tourmalines.

Borate exists in many forms. In acid and near-neutral conditions, it is boric acid. Members of the borate family of solid pesticides include pentahydrate borax, disodium octaborate tetrahydrate, boric acid, orthoboric acid, and borax. Borax is a generic name used to describe a number of closely related minerals or chemical compounds, such as anhydrous borax, borax pentahydrate and borax decahydrate. The borax term is most usually used to describe borax decahydrate. Borax, also called sodium borate or sodium tetraborate, is a soft white many-sided crystal. An example of a commercially available borate powder used as a pesticide is Boracide, available from Nisus Corporation of Rockford, Tenn.

Another example of a solid pesticide that may be used with the pesticide distribution system 100 is a dry, powder solution including pyrethrins as the active ingredient. Pyrethrins are a pair of natural organic compounds that have potent insecticidal activity. Pyrethrins are neurotoxins that attack the nervous systems of all insects. When present in amounts not fatal to insects, they still appear to have an insect repellent effect. The chemical structure of pyrethrins is the basis for a variety of synthetic insecticides called pyrethroids, such as permethrin and cypermethrin. In one embodiment of the present invention, pyrethrins can be mixed in a solid pesticide solution with piperonyl butoxide and amorphous silica gel, such as in the commercially available pesticide Drione, available from Bayer Environmental Science of Montvale, N.J.

Additional examples of solid pesticides that may be used with the pesticide distribution system 100 include dry, powder solutions having any one of the following chemicals as the active ingredient: deltamethrin, 2-phenethyl propionate, cyfluthrin, silicon dioxide, eugenol, amphorous silica, piperonyl butoxide, rosemary, mint and corn gluten meal.

Solid, or dry, pesticides are vastly different from conventional wet, or liquid, pesticides, such as resmethrin, or gas pesticides for a variety of reasons. Solid pesticides also offer a range of benefits over liquid or gas pesticides. First, solid pesticides are dry and do not promote the growth of mold, which is commonly associated with liquid pesticides. Mold is currently a widely held public health concern.

Second, solid pesticides do not require pressurization and/or compression in order to apply them. Expansion is a phenomena experienced by a substance that is pressurized and/or compressed. Only gases and liquids can be compressed—solids cannot be compressed. Therefore, solid pesticides cannot be compressed and thus cannot expand. Liquid and gas pesticides require pressurization and/or compression within a container in order to allow them to expand when they are applied. Consequently, solid pesticides do not require pressurized devices or apparatuses to deliver the pesticide, as required by expanding pest control substances, such as liquids or gases.

Third, solid pesticides have a better safety record than liquid or gas pesticides. Lastly, solid pesticides last longer in their native state and may be exposed to the atmosphere without drying up or dissipating. When liquid or gas pesticides are exposed to the atmosphere they may dry up, dissipate or sublimate.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A system for distributing a solid pesticide within interior cavities of a building, comprising:
a panel coupled to an exterior wall of the building;
at least one orifice in the panel providing access to an interior cavity of the building, wherein the at least one orifice comprises an exterior-facing end and an interior-facing end;
a plurality of tubes located within interior cavities of the building, wherein each of the plurality of tubes comprises a plurality of apertures for expelling a solid pesticide and wherein each of the plurality of tubes is coupled at an open end to an interior-facing end of at least one orifice in the panel; and
a solid powder pesticide that is injected into an exterior-facing end of the at least one orifice, thereby distributing the solid powder pesticide throughout the interior cavities of the building via the plurality of tubes.

2. The system of claim 1, wherein the solid powder pesticide comprises a borate in powder form.

3. The system of claim 2, wherein the solid powder pesticide comprises any one of disodium octaborate tetrahydrate, pentahydrate borax, boric acid and orthoboric acid in powder form.

4. The system of claim 1, wherein the solid powder pesticide comprises pyrethrins in powder form.

5. The system of claim 1, wherein the solid powder pesticide comprises any one of the following chemicals in powder form:
deltamethrin;
cyfluthrin;
silicon dioxide;
2-phenethyl propionate;
amphorous silica;
piperonyl butoxide;
rosemary;
mint; and
corn gluten meal.

6. The system of claim 5, wherein an open end of each of the plurality of tubes is directly inserted into an interior-facing end of at least one orifice in the panel.

7. The system of claim 6, wherein each of the plurality of tubes comprises a polymer tube of about 3/16inch in diameter.

8. A method for providing a system for distributing a solid pesticide within interior cavities of a building, comprising:
installing a panel coupled to an exterior wall of the building, wherein the panel includes at least one orifice providing access to an interior cavity of the building and wherein the at least one orifice comprises an exterior-facing end and an interior-facing end;
installing a plurality of tubes located within interior cavities of the building, wherein each of the plurality of tubes comprises a plurality of apertures for expelling a solid pesticide and wherein each of the plurality of tubes is coupled at an open end to an interior-facing end of at least one orifice in the panel; and
injecting a solid powder pesticide into an exteriorfacing end of the at least one orifice, thereby distributing the solid powder pesticide throughout the interior cavities of the building via the plurality of tubes.

9. The method of claim 8, wherein the method for providing comprises:
a method for providing a system for distributing a solid pesticide &omprising a borate in powder form within interior cavities of a building.

10. The method of claim 9, wherein the method for providing comprises:
a method for providing a system for distributing a solid pesticide comprising any one of disodium octaborate tetrahydrate, pentahydrate borax, boric acid and orthoboric acid in powder form within interior cavities of a building.

11. The method of claim 8, wherein the method for providing comprises:
a method for providing a system for distributing a solid pesticide comprising pyrethrins in powder form within interior cavities of a building.

12. The method of claim 8, wherein installing a panel further comprises fastening the panel to an exterior wall of the building.

13. The method of claim 12, wherein installing a plurality of tubes further comprises threading at least one of the plurality of tubes through horizontal channels in vertical studs within interior cavities of the building.

14. The method of claim 13, wherein installing a plurality of tubes further comprises fastening at least one of the plurality of tubes to horizontal studs within interior cavities of the building.

15. The method of claim 6, wherein installing a plurality of tubes further comprises installing a plurality of tubes located within interior cavities of the building, wherein each of the plurality of tubes comprises a plurality of apertures for expelling a solid pesticide and wherein an open end of each of the plurality of tubes is directly inserted into an interior-facing end of at least one orifice in the panel.

16. A method for distributing a solid pesticide within interior cavities of a building, comprising:
inserting a nozzle of a dust applicator into at least one orifice in a panel coupled to an exterior wall of the building;
injecting a solid powder pesticide from the dust applicator into the at least one orifice, wherein each of the at least one orifices provide access to a tube extending within interior cavities of the building and wherein each tube comprises a plurality of apertures for expelling the solid powder pesticide, thereby distributing the solid powder pesticide throughout the interior cavities of the building via each tube; and
injecting an inert gas into the at least one orifice in the panel, thereby flushing solid powder pesticide remaining within each tube into the interior cavities of the building via the plurality of apertures in each tube.

17. The method of claim 16, wherein the method for distributing a solid pesticide comprises:
a method for distributing a solid pesticide comprising a borate in powder form within interior cavities of a building.

18. The method of claim 17, wherein the method for distributing a solid pesticide comprises:
a method for distributing a solid pesticide comprising any one of disodium octaborate tetrahydrate, pentahydrate borax, boric acid and orthoboric acid in powder form within interior cavities of a building.

19. The method of claim 16, wherein the method for distributing a solid pesticide comprises: a method for distributing a solid pesticide comprising pyrethrins in powder form within interior cavities of a building.

20. (canceled)
